(19) United States
(12) Patent Application Publication
(10) Pub. No.: US 2004/0001021 A1
(43) Pub. Date: Jan. 1, 2004

(54) Microstrip antennas and methods of designing same

(76) Inventors: Hosung Choo, Austin, TX (US); Hao Ling, Austin, TX (US)

Correspondence Address: ERIC B. MEYERTONS, CONLEY, ROSE & TAYON, P.C., P.O. BOX 398, AUSTIN, TX, 78767-0398, US

(21) Appl. No.: 10/320,801

(22) Filed: Dec. 16, 2002

Related U.S. Application Data
(60) Provisional application No. 60/340,801, filed on Dec. 14, 2001.

(51) Int. Cl. H01Q 1/38

(52) U.S. Cl. 343/700 MS

(57) ABSTRACT

The use of a genetic algorithm (GA) to design patch shapes of microstrip antennas for multi-band applications is disclosed. A full-wave electromagnetic solver is used to predict the performance of microstrip antennas with arbitrary patch shapes. Two-dimensional chromosomes are used to encode each patch shape into a binary map. GA with two-point crossover and geometrical filtering is implemented to achieve efficient optimization. The GA-optimized designs are built on a solid substrate (e.g., FR-4). The patch shape may be further optimized to broaden the bandwidth at one or more of the frequencies. In addition to multi-band operation in frequency, designs based on other objectives, including size miniaturization and/or circular polarization are disclosed.

The design of dual-band microstrip antennas using genetic algorithms was addressed by Johnson and Rahmat-Samii in the paper “Genetic Algorithms and Method of Moments (GA/MOM) for the Design of Integrated Antennas,” which is incorporated herein by reference. An air substrate was used in their study. The Johnson and Rahmat-Samii method of designing dual-band microstrip antennas for an air substrate involved selecting a “mother” structure. The method then removed portions of the mother structure to search for an optimal substructure contained within the mother structure that comes closest to meeting the design goals. (J. M. Johnson and Y. Rahmat-Samii, “Genetic Algorithms and Method of Moments (GA/MOM) for the Design of Integrated Antennas,” IEEE Trans. Antennas Propagat., vol. 47, pp. 1606-1614, October 1999.)

### SUMMARY OF THE INVENTION

In an embodiment, a numerical method may be use to determine an optimal shape for a microstrip antenna having specific characteristics. For example, a genetic algorithm (GA) may be used to design optimal shapes for microstrip antennas to achieve multi-band operation. In another example, a GA may be use to design an optimal shape for a microstrip antenna having a broad bandwidth. In an embodiment, such methods may be used to design antennas formed on a solid substrates (e.g., FR-4 or other dielectric material).

Using numerical shape optimization desired operational characteristics of an antenna (e.g., broad bandwidth, multi-band operation, etc.) may be achieved with little or no increase in overall volume or manufacturing cost. Additionally, such methods may be constrained so that continuous shapes are formed. Continuous forms may be more readily manufacturable. In an embodiment of a GA implementation, a two-point crossover scheme involving three chromosomes may be used. A two-point crossover scheme using three chromosomes may have an advantage over a single-point crossover scheme using two chromosomes in that faster convergence may be demonstrated. Furthermore, geometrical filtering may be applied to each chromosome to obtain a more realizable shape (e.g., a continuous shape). Additionally, GA-optimized shapes for antennas having multi-band operation are presented. It is also shown that arbitrary frequency ratios between the two frequencies for dual band antennas ranging from 1:1.1 to 1:2 may be achieved through the GA design.

In an embodiment, a method of designing an antenna by numerical optimization may include selecting an initial chromosome placement using an optimization routine. Such an embodiment may not require that a “mother” shape be pre-selected. It is believed that such methods may provide improved optimization of the final antenna shape. Additional, it is believed that such methods may provide for a more rapid solution of optimization equations, which may allow more complex, more detailed and/or higher performance antenna designs.

### BRIEF DESCRIPTION OF THE DRAWINGS

Other objects and advantages of the invention will become apparent upon reading the following detailed description and upon reference to the accompanying drawings in which:

FIG. 1 depicts a flow chart of a method of designing an antenna using a genetic algorithm according to an embodiment;

FIG. 2 depicts a method varying the resolution of a chromosome according to one embodiment;

FIG. 3 depicts an embodiment of a one-point crossover scheme using two chromosomes;

FIG. 4 depicts an embodiment of a two-point crossover scheme using three chromosomes;

FIG. 5 depicts a chart comparing convergence of a one-point crossover scheme using two chromosomes and a two-point crossover scheme using three chromosomes according to an embodiment;

FIG. 6 depicts an embodiment of a chromosome before and after geometric filtering;

FIG. 7a depicts an embodiment of a GA optimized dual-band microstrip antenna having a frequency ratio of 1:1.5;

FIG. 7b depicts a frequency response curve corresponding to the antenna shape of FIG. 7a;

FIG. 8a depicts an embodiment of a GA optimized dual-band microstrip antenna having an optimized low band;

FIG. 8b depicts predicted and measured frequency response curves corresponding to the antenna shape of FIG. 8a;

FIGS. 8c and 8d depict measured boresight radiations for two diagonally oriented polarizations of the antenna shape of FIG. 8a;

FIG. 9a depicts an embodiment of a GA optimized dual-band microstrip antenna having a frequency ratio of 1:1.2 and a frequency response curve corresponding to the antenna shape;

FIG. 9b depicts an embodiment of a GA optimized dual-band microstrip antenna having a frequency ratio of 1:1.4 and a frequency response curve corresponding to the antenna shape;

FIG. 10 depicts an embodiment of a GA optimized dual-band microstrip antenna having a frequency ratio of 1:1.1;

FIG. 11 depicts an embodiment of a GA optimized dual-band microstrip antenna having a frequency ratio of 1:1.2;

FIG. 12 depicts an embodiment of a GA optimized dual-band microstrip antenna having a frequency ratio of 1:1.3;

FIG. 13 depicts an embodiment of a GA optimized dual-band microstrip antenna having a frequency ratio of 1:1.4;

FIG. 14 depicts an embodiment of a GA optimized dual-band microstrip antenna having a frequency ratio of 1:1.5;

FIG. 15 depicts an embodiment of a GA optimized dual-band microstrip antenna having a frequency ratio of 1:1.6;

FIG. 16 depicts an embodiment of a GA optimized dual-band microstrip antenna having a frequency ratio of 1:1.7;

FIG. 17 depicts an embodiment of a GA optimized dual-band microstrip antenna having a frequency ratio of 1:1.8;

FIG. 18 depicts an embodiment of a GA optimized dual-band microstrip antenna having a frequency ratio of 1:1.9;

FIG. 19 depicts an embodiment of a GA optimized dual-band microstrip antenna having a frequency ratio of 1:2;

FIG. 20 depicts a frequency response curve corresponding to the antenna shape of FIG. 10;

FIG. 21 depicts a frequency response curve corresponding to the antenna shape of FIG. 11;

FIG. 22 depicts a frequency response curve corresponding to the antenna shape of FIG. 12;

FIG. 23 depicts a frequency response curve corresponding to the antenna shape of FIG. 13;

FIG. 24 depicts a frequency response curve corresponding to the antenna shape of FIG. 14;

FIG. 25 depicts a frequency response curve corresponding to the antenna shape of FIG. 15;

FIG. 26 depicts a frequency response curve corresponding to the antenna shape of FIG. 16;

FIG. 27 depicts a frequency response curve corresponding to the antenna shape of FIG. 17;

FIG. 28 depicts a frequency response curve corresponding to the antenna shape of FIG. 18;

FIG. 29 depicts a frequency response curve corresponding to the antenna shape of FIG. 19;

FIG. 30a depicts an embodiment of a GA optimized dual-band microstrip antenna having a frequency ratio of 1:1.3;

FIG. 30b depicts a schematic side view of an embodiment of an antenna constructed with the shape of FIG. 24a;

FIG. 30c depicts predicted and experimental frequency response curves corresponding to the antenna of FIG. 24a;

FIG. 31a depicts an embodiment of a tri-band microstrip antenna;

FIG. 31b depicts a side view of the microstrip antenna of FIG. 31a built on FR-4 substrate;

FIG. 31c depicts predicted and experimental frequency response curves corresponding to the antenna of FIG. 31a;

FIG. 32a depicts an embodiment of a quad-band microstrip antenna;

FIG. 32b depicts predicted and experimental frequency response curves corresponding to the antenna of FIG. 32a;

FIG. 33a depicts an embodiment of a broadband circularly polarized microstrip antenna;

FIG. 33b depicts a graph of the axial ratio (dB) of the antenna of FIG. 33a;

FIG. 33c depicts a graph of the return loss (dB) of the antenna of FIG. 33a;

FIG. 34 depicts a graph of microstrip antenna size versus bandwidth percent according to an embodiment;

FIG. 35a depicts a microstrip antenna with determined slot dimensions and placement according to an embodiment; and

FIG. 35b depicts a graph of the return loss (dB) of the antenna of FIG. 35a.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Methods of designing microstrip antennas and matters relevant to the design of microstrip antennas are discussed in the following publications, which are incorporated by reference as though fully set forth herein: Handbook of Microstrip Antennas by J. R. James and P. S. Hall; “Creation of New Shapes for Resonant Microstrip Structures by Means of Genetic Algorithms” by M. Villegas and O. Picon; “Scattering from a Periodic Array of Free-Standing Arbitrarily Shaped Perfectly Conducting or Resistive Patches” by T. Cwik and R. Mittra; “Electromagnetic Scattering from Frequency Selective Surfaces” by L. C. Trintinalia; “Shape Optimization of Broadband Microstrip Antennas Using the Genetic Algorithm” by H. Choo, A. Hutani, L. C. Trintinalia, and H. Ling; Project Summary of Proposal #0036558 entitled “Design of Miniaturized Antennas for Wireless Communications” by H. Ling, R. Rogers and H. Foltz; “Design of Broadband and Dual-Band Microstrip Antennas on FR-4 Substrate Using Genetic Algorithms” by H. Choo and H. Ling, “Shape Optimization of Printed Patch Absorber and Microstrip Antenna Structures Using the Genetic Algorithm” by H. Choo; U.S. Pat. No. 4,692,769 to Gegan; U.S. Pat. No. 6,211,825 to Deng; and U.S. Pat. No. 6,225,958 to Amano et al.

Microstrip antennas that can operate in multiple frequency bands are used in many wireless communication devices. Embodiments presented herein describe antennas having novel patch shapes that can achieve two, three or four frequency bands of operation. These shapes may be designed using a numerical optimization method (e.g., a genetic algorithm) also disclosed herein. In an embodiment, such an antenna may be designed to allow an electronic device to communicate over a desired combination of frequency bands. For example, it may be desirable for an electronic device to communicate with other electronic devices or communications networks, such as but not limited to a global positioning satellite system (GPS), one or more cellular or personal communication networks (DCS, GSM, etc.), a local device or network (e.g., Bluetooth, ISM, 802.11b, 802.11a, etc.) and/or a satellite communications system (e.g., X-band). A multi-band microstrip for such a device may be designed to operate in frequencies used by such communications networks or devices. For example, an antenna may be designed to operate at about 0.9 GHz (GSM900), 1.2 GHz (GPS/L2), 1.6 GHz (GPS/L1), 1.8 GHz (DCS), 1.9 GHz (GSM1900), 2.45 GHz (ISM/Bluetooth, 802.11b, 802.11a), 5.2 GHz (NII), 5.4 GHz (NII), 8-12 GHz (X-band) and/or one or more other frequencies.

Additional embodiments presented herein relate to microstrip antennas having circular polarization (CP). Microstrip antennas having CP have been used in satellite and mobile communication systems to inhibit propagation effects and overcome fading. However, conventional CP microstrip antennas tend to have narrow CP bandwidth. For instance, the CP bandwidth (with an axial ratio less than 3 dB) of a square microstrip may be less than about 1% on FR-4 substrate. Embodiments disclosed herein include novel patch shapes that achieve good CP bandwidth (e.g., about 1.3%). Such patch shapes may be designed using numerical optimization techniques such as those disclosed herein.

Additional embodiments presented herein relate to miniaturized antennas. As the size of wireless handheld devices shrinks, the demand for miniaturized antennas is increasing. However, miniaturization may impact antenna efficiency and bandwidth. Both efficiency and bandwidth may be important parameters in high data rate, low power consumption devices. Embodiments presented herein provide methods for producing microstrip antenna designs with sizes smaller than typical microstrip antennas. The design methodology may be applied to search for optimal patch shapes and shorting pin placement to achieve the smallest possible patch size, while preserving antenna bandwidth and efficiency.

In an embodiment, a numerical optimization technique for antenna design may use a genetic algorithm (GA). As used herein, “genetic algorithm” is intended to include the concept of evolutionary algorithms of which genetic algorithms may generally be considered a subset. A GA optimization method may be implemented to optimize a microstrip patch shape in order to achieve multi-band operation, broad band operations and/or one or more other characteristics (e.g., efficiency, size, etc) of an antenna. Other deterministic and/or non-deterministic numerical optimization techniques (e.g., simulated annealing) may also be used for antenna design.

As used herein, a GA refers to a non-deterministic computational system metaphorically related to natural evolutionary processes. As a result, GAs may be described in terms associated with biological processes. For example, a “species” may refer to an individual solution of a GA. A referenced species may or may not be an optimum solution of the GA. A GA may determine species by processes referred to as mutation, cross-over and/or selection, etc. In the context of antenna design using a GA, a “chromosome” generally refers to an individual embodiment of an antenna shape.

In an embodiment, a method of using a GA for antenna design may use a two-dimensional (2-D) chromosome to encode each patch shape into a binary map. In an embodiment, a design matrix (including a number of individual locations, or pixels) may be mathematically constructed. The design matrix may represent a physical embodiment of an area available for construction of an antenna. That is the design matrix may correspond to a specific area on an antenna substrate. The design matrix may be divided into a plurality of matrix elements. The number of matrix elements may specify the resolution of the binary map. Each matrix element of a design matrix may correspond to a location on the substrate. For example, a 16×16 design matrix may have 256 matrix elements (i.e., 16 times 16), which represent 256 locations on the substrate. Similarly, a 32×32 design matrix may have 1024 matrix elements. A matrix element may be turned on indicating the presence of a conductor at the location specified by the matrix element. Alternately, a matrix element may be turned off indicating the absence of a conductor at the location specified by the matrix element. In computationally manipulating the design matrix, the matrix elements may be represented by a binary system. For example, conductive areas may be represented by ones and non-conductive areas may be represented by zeros.

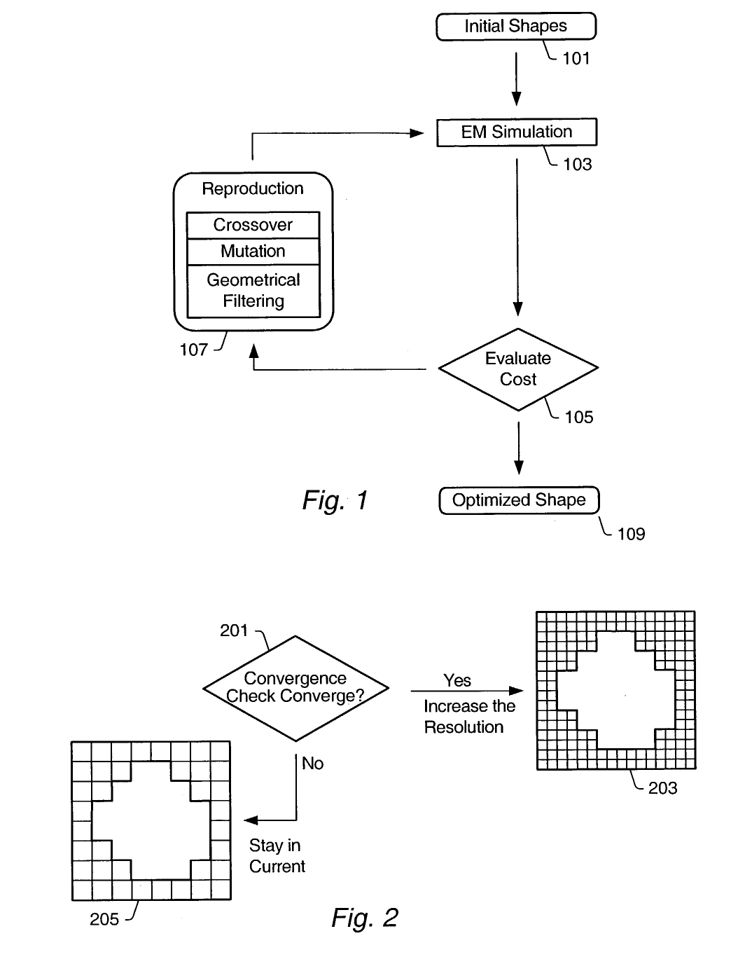

FIG. 1 is a flow chart of a basic GA method according to one embodiment. The GA starts with an initial population of shapes at step 101. The initial population of shapes may be determined by the method (e.g., arbitrarily, randomly or according to another selection method) and/or specified by a user. The shapes are encoded as 2-dimensional chromosomes for computation. The initial chromosomes may be evaluated by an electromagnetic (EM) simulation code at step 103. A cost function may then be computed at step 105. Based on the cost function, the next generation of chromosomes (i.e., encoded shapes) may be regenerated by a reproduction process at step 107. The reproduction process may involve crossover, mutation and geometrical filtering. EM simulation 103, cost evaluation 105 and reproduction 107 may be iteratively repeated until the cost function is minimized, resulting in an optimized antenna shape as indicated by step 109.

In an embodiment, a coarse-to-fine variation method may be used to save computation time. To get a better design, it may be necessary to use a fine design grid resolution (i.e., a relatively large number of matrix elements). However, the use of a fine design grid may considerably increase computational cost and time. For example, the calculation time for one shape may scale proportional to N³, where N is the number of matrix elements in the design grid. In order to use a fine design grid resolution without creating an excessive computational burden, a coarse-to-fine variation method may be introduced into the GA.

As used herein, a “coarse-to-fine variation” method refers to initiating the GA with a coarse design grid resolution, then increasing the number of matrix elements of the design grid as the GA approaches convergence. FIG. 2 depicts how a coarse-to-fine variation method may work in one embodiment. In an embodiment, evaluating the cost function (step 105 of FIG. 1) may include a convergence check 201. The method of FIG. 1 may start with a coarse design grid resolution. The GA may iteratively find a result that has the lowest cost for this resolution (e.g., the cost converges to a minimum value). If the cost value satisfies specified design goals, the method may stay at the coarse resolution and stop at an optimized shape, as shown at step 205. However, if the cost does not satisfy one or more specified design goals when convergence check 201 indicates that a minimum has been reached, then the resolution of the design grid may be increased at step 203. For example, the resolution may be doubled. The antenna design shape may be already partially optimized with the coarse resolution. Therefore, at higher resolutions, the GA may only need to tune the results. This variable resolution of the design grid from coarse to fine may save computation time as compared to starting with a fine resolution.

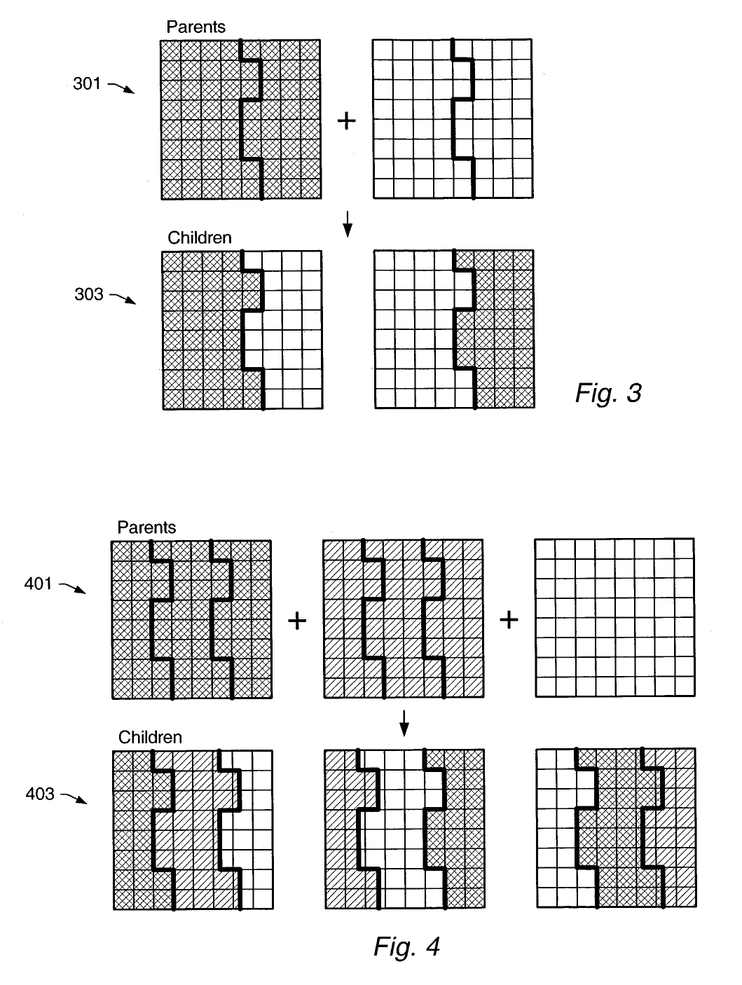

In 2-D GA optimization, 2-D crossover may be used. FIG. 3 shows a commonly used 2-D one-point crossover. It starts from selecting two chromosomes 301 and divides each as two parts. Then the next generation 303 is made by shuffling the two chromosomes.

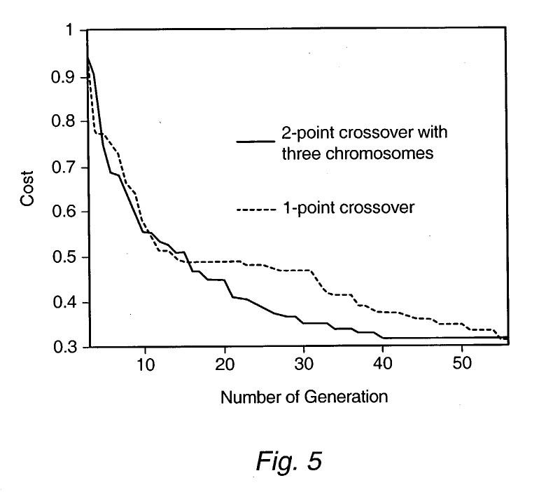

In an embodiment, a 2-point crossover with three chromosomes may be used to boost the convergence rate. FIG. 4 depicts a methodology of 2-point crossover with three chromosomes, according to one embodiment. The process starts with selecting three chromosomes as parents 401. Each chromosome is then divided into three parts. The next generation 403 may be made by intermingling the three parent chromosomes. 2-point crossover tends to exhibit more disruptive characteristics for each generation as compared to 1-point crossover. This disruptive nature of 2-point crossover in conjunction with a 2-D GA process like geometrical filtering tends to show better convergence and may be a constructive effect. For example, a comparison of the results between a 2-point crossover method with three chromosomes and a 1-point crossover method with two chromosomes is depicted in FIG. 5. A population of 30, a crossover rate of 0.8 and a mutation rate of 0.1 are used in each case. In addition, a geometrical filter is used. FIG. 5 demonstrates that the 2-point crossover method tends to have a faster convergence rate than the 1-point crossover method in 2-D.

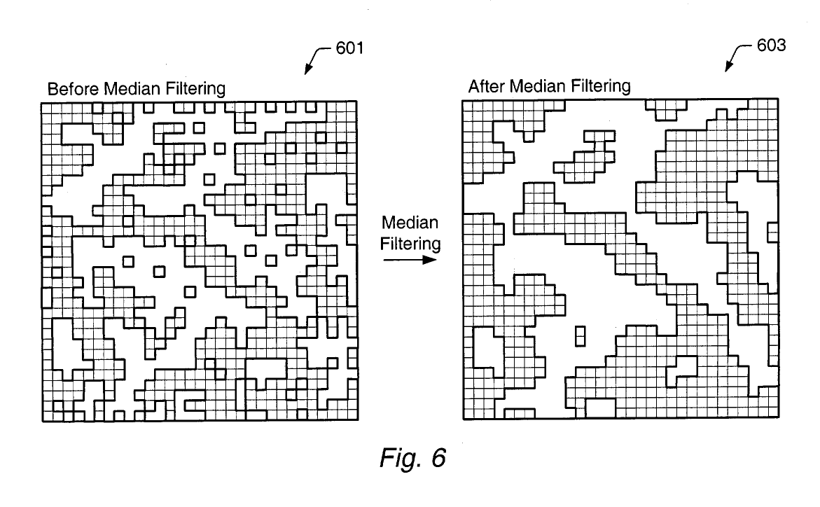

It is believed that obtaining optimized patch shapes that are well connected (e.g., continuous) may be desirable from the manufacturing point of view. Therefore, a 2-D median filter (or geometric filter) may be applied to the chromosomes to create a more realizable population at each generation of the GA. FIG. 6 depicts a sample chromosome before and after a median filter operation according to one embodiment. Before median filtering, the chromosome 601 shows many isolated patches. After median filtering, most of the isolated patches in the chromosome 603 are gone, and the overall shape of the chromosome looks more gathered. By using median filtering, the searching space for the GA may be focused on the more realizable populations. Thus, the total searching space of the GA may be reduced. This trimmed down searching space may reduce the overall GA convergence time. Thus, median filtering may enable using larger sizes of design grids and/or higher resolution design grids. For instance, without median filtering, a fine resolution design that has a design grid size of more than about 16×16 may be prohibitively time consuming because of the extremely slow convergence rate. However, with median filtering, a fine resolution design that has a design grid size of about 32×32 may be obtained without being prohibitively time consuming.

To evaluate the performance of each patch shape, a full-wave periodic patch code adapted from a frequency selective surface code may be used. Electromagnetic analysis may be carried out by using the electric-field integral equation (EFIE). The periodic Green's function for a layered medium may be used as the kernel of the integral equation. Rooftop basis functions may be used to expand the unknown current on the metal patch. A fast Fourier transform (FFT) may be used to accelerate the computation of the matrix elements. To reduce the matrix fill-time, the matrix element calculation may be done only once and stored before the GA process. Because of the assumed periodicity in the patch code, a period that is greater than one wavelength may be used to avoid coupling between the adjacent patches for a single patch simulation. To achieve multi-band design, an additive cost function may be defined as:

$$Cost = \frac{1}{N} {\sum }_{n = 1}^{N} ( {P}_{n} + {Q}_{n} ) \\ where \\ {P}_{n} = \{ \begin{matrix}{S}_{11} ( dB ) + 10 dB & if {S}_{11} ( dB ) \geq - 10 dB \\ 0 & if {S}_{11} ( dB ) < - 10 dB\end{matrix} \\ {Q}_{n} = \sqrt{\frac{w μ}{2 σ}} {\int }_{s} {\vert {J}_{s} \vert}^{2} ⅆ s ( dB ) \qquad ( 1 )$$

The first part of the cost function may account for the impedance mismatch and may be defined as the average of those return loss (S₁₁) values that exceed −10 dB (e.g., VSWR=2:1) within the frequency bands of interest. The second part of the cost function may account for the total metal loss (dB) generated by the current flowing on the patch. In this example, the conductivity of aluminum (q=3.82×10⁷ S/m) is used, and the microstrips used for physical measurements were built using aluminum tape. However, the cost function may be defined in terms of other materials to design antennas constructed from materials other than aluminum.

In an embodiment, one or more first chromosomes may be selected at random from the design matrix. The first chromosomes become the parent chromosomes. Future generations are subsequently determined from parent chromosomes. Based on the cost function, the next generation may be created by a reproduction process that involves crossover, mutation and/or 2-D median filtering. As previously described, a two-point crossover scheme involving three chromosomes may be used. The GA process may be iterated until the cost function converges to a minimum value. In certain embodiments, if the antenna does not meet minimum design requirements when a minimum value of the cost function is reached, the resolution of the design grid may be increased.

The examples below describe various rmicrostrip antenna designs. The design goals and results are described where appropriate.

### EXAMPLE 1

### Dual-Band Antennas

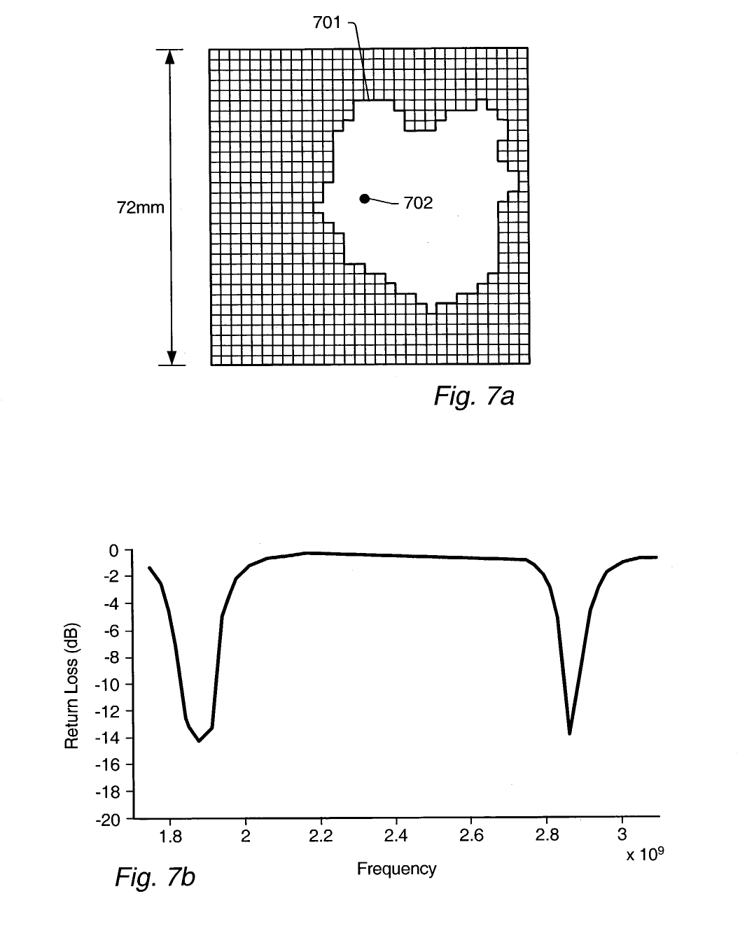

FIG. 7a shows a microstrip shape for dual-band operation determined by a numerical optimization technique. A 72 mm×72 mm square design matrix in which the conductive patches may reside was discretized into a 32×32 grid for the chromosome definition. Other shapes, dimensions and/or resolutions of the design matrix could have been selected. For example, the shape and/or dimensions of the design matrix may be selected to fit within a particular application (e.g., a cell phone casing or other communications device). Similarly, the design grid size and/or resolution may be selected to allow an antenna designed by the method to be manufactured on available manufacturing equipment. Each square of the design matrix corresponds mathematically to a matrix element. In the example, the thickness of the FR-4 substrate (dielectric constant of about 4.3) is about 1.6 mm. Other substrates or other dimensions of the substrate could have been selected. The antenna patch is indicated by reference numeral 701. The position of the probe feed is indicated by reference numeral 702. FIG. 7b shows the predicted return loss (|S₁₁|in dB) of a microstrip antenna constructed according to the design depicted in FIG. 7a. In FIG. 7b, good matches are exhibited by the return loss curve at the design frequencies of 1.9 GHz and 2.85 GHz. The bandwidths at the two design frequencies are about 4% and 1.4%, respectively.

### EXAMPLE 2

### Dual-Band Antennas

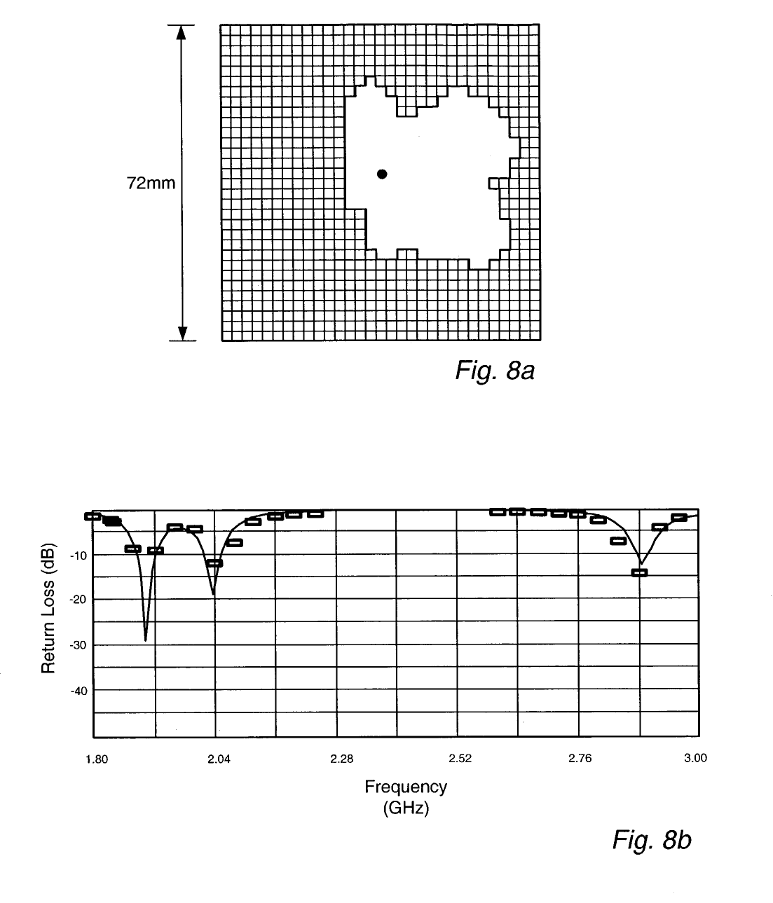

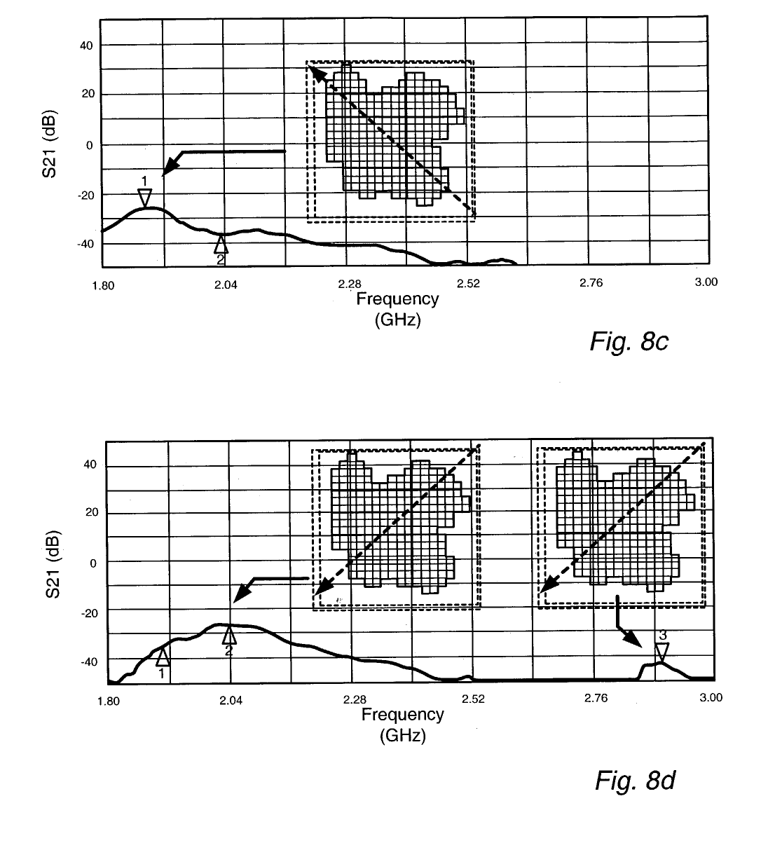

Experiments were conducted to determine the effectiveness of using a GA to broaden the operational bandwidth of the dual-band microstrip antennas (as described above). The low frequency (1.9 GHz) was chosen to be the target for broadbanding. The bandwidth of high frequency was kept the same. Using the GA method previously described, the value of the frequency range centered at 1.9 GHz was gradually increased in the cost function definition until the desired broadband design was achieved. That is, the cost function was modified to increase the cost associated with the frequency range centered at 1.9 GHz. FIG. 8a shows a bandwidth-enhanced dual-band result. A microstrip patch designed by such a method was constructed. Performance of the microstrip patch was then measured. FIG. 8b shows the measured and simulated return loss for an antenna having the shape depicted in FIG. 8a. In FIG. 8b the square dots show the predicted values based on a computer simulation of the antenna design and the line shows the measure values of the constructed microstrip patch. Good agreement was observed between the measurement and simulation results. FIGS. 8c and 8d show the measured boresight radiations (S₂₁ dB) for the two diagonally oriented polarizations. It is noted that near 1.9 GHz, there are two modes with orthogonal current directions at two closely spaced frequencies, leading to the broadening of the impedance bandwidth in FIG. 8b. At 2.9 GHz, only a single mode exists.

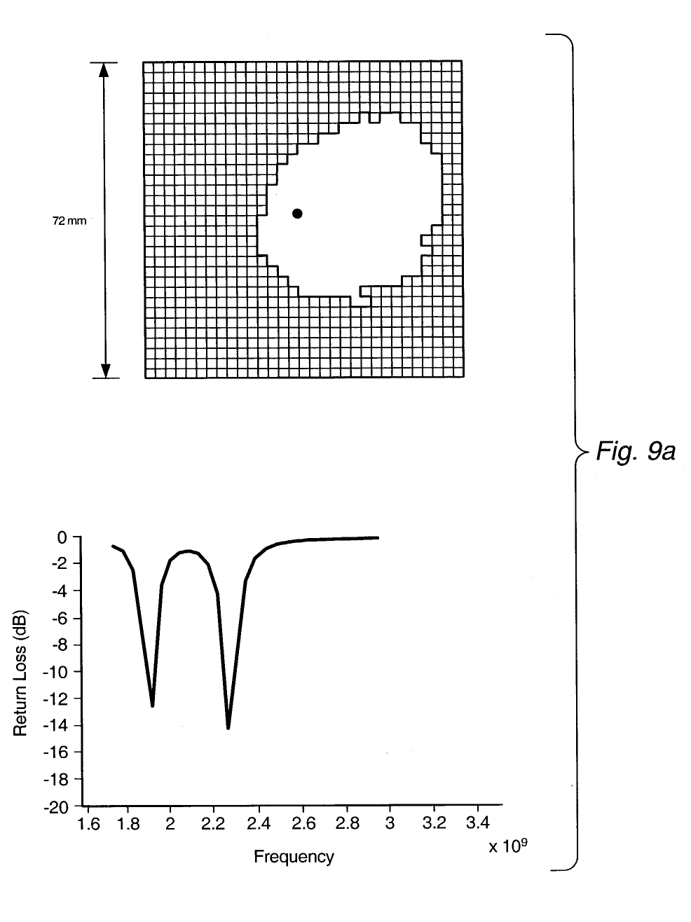

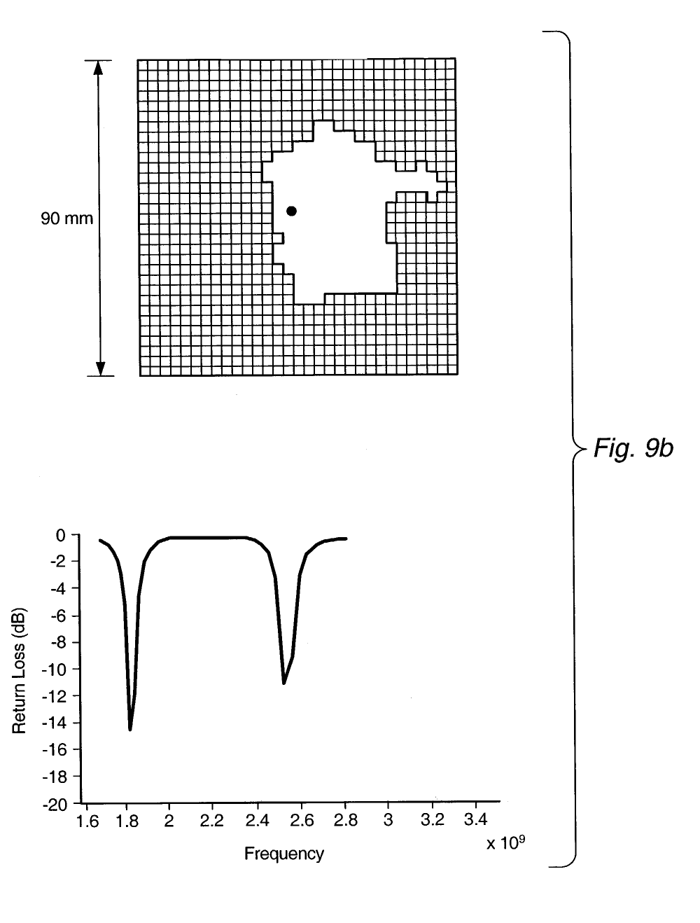

In the above examples, the ratio between the two frequency bands was chosen to be about 1:1.5. Experiments have also been carried out using the dual-band design steps and GA to achieve different frequency ratios between the low and the high frequency bands. During these experiments, the low frequency band was fixed at about 1.9 GHz, while the frequency of the high frequency band was varied. Frequency ratios from 1:1.1 to 1:2 were addressed using GA. FIGS. 9a and 9b show the resulting optimized shapes and the corresponding return loss versus frequency curves for the frequency ratios 1:1.2, and 1:1.4, respectively. As confirmed by these experiments, using the GA methods disclosed herein it is possible to design dual-band antennas at least throughout the entire dual-band frequency ratio from 1:1.1 to 1:2. It is believed that the GA design methods disclosed herein may be applicable outside this range as well.

Additional Dual-Band Antenna Examples:

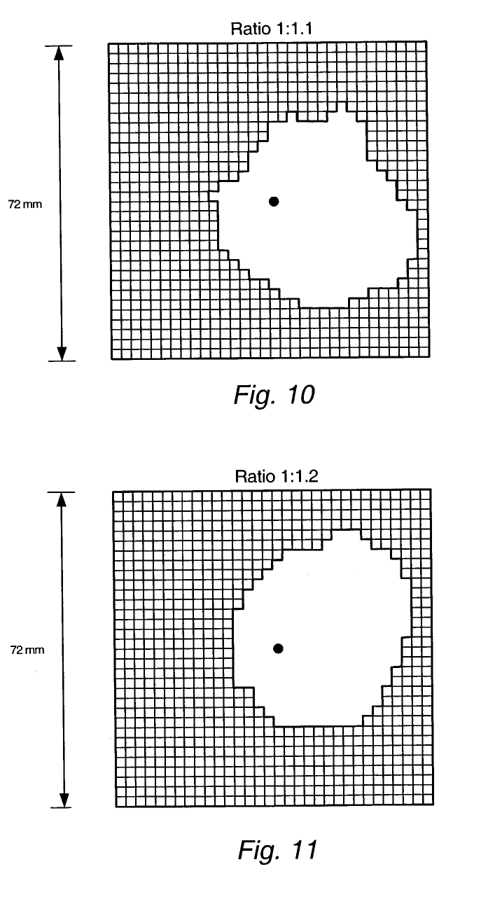

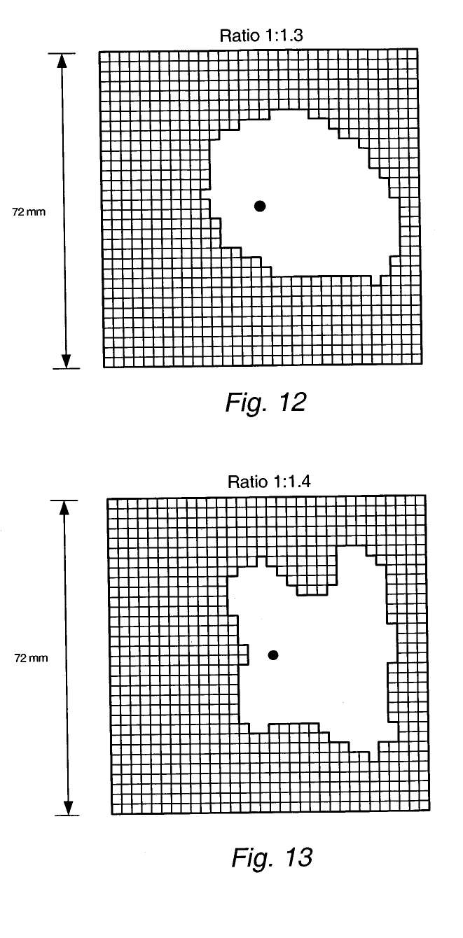

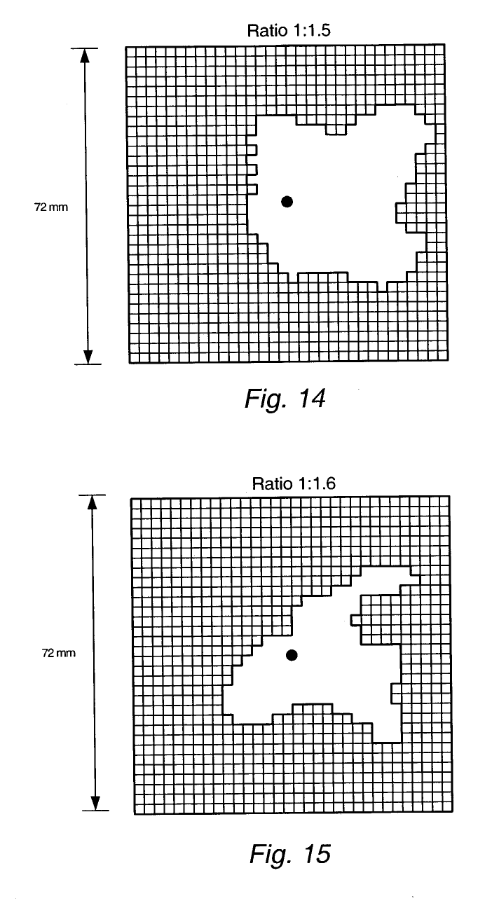

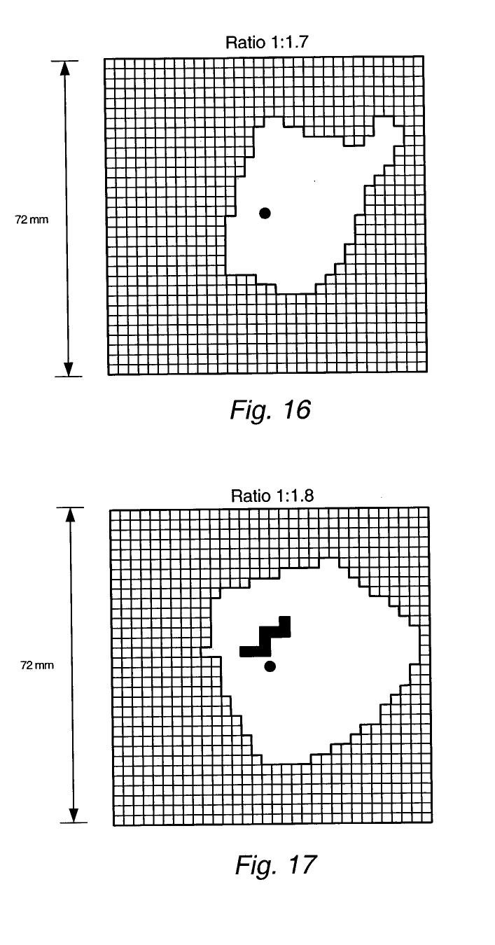

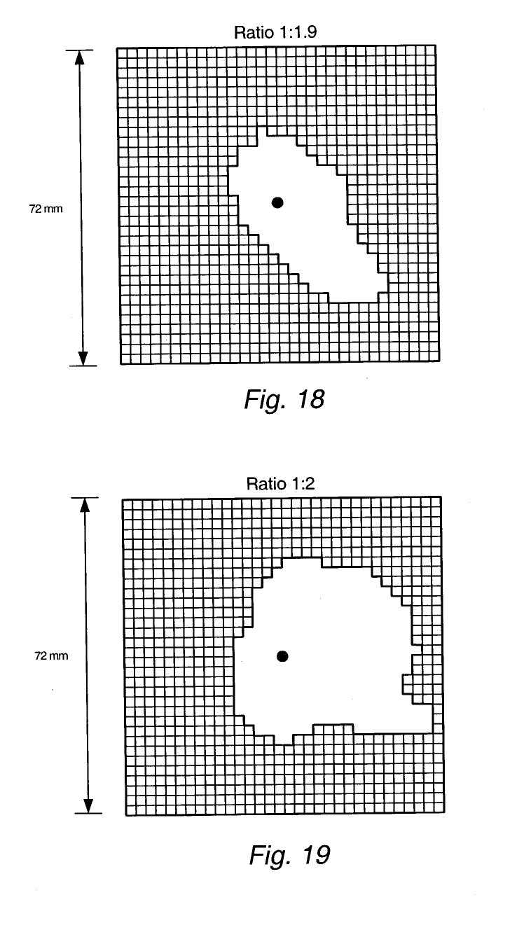

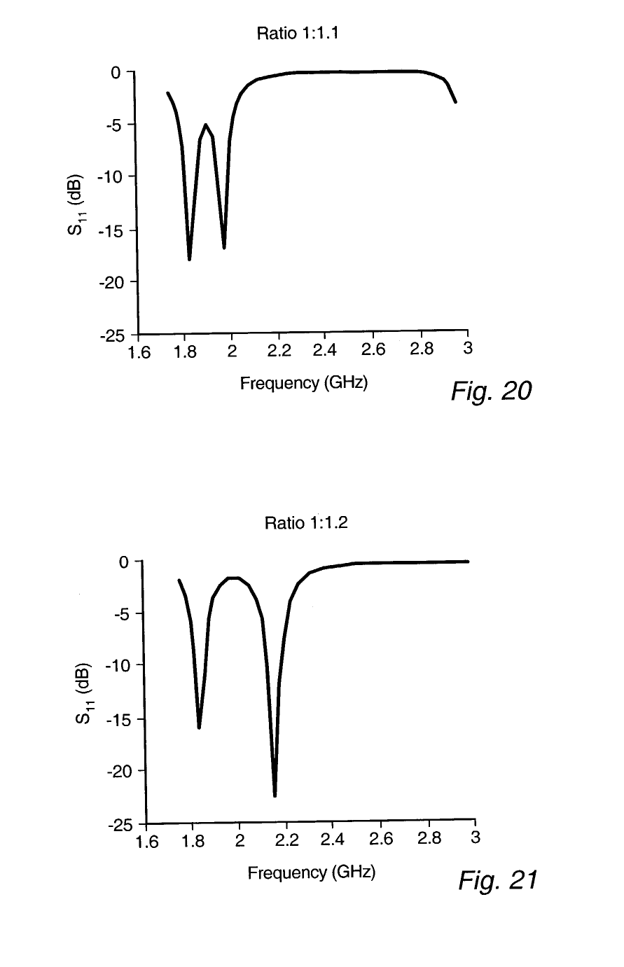

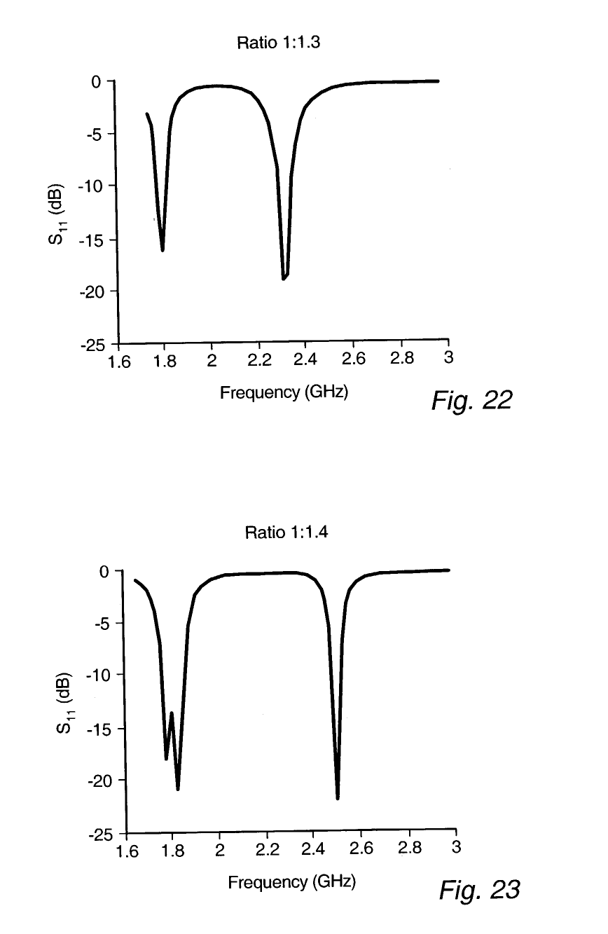

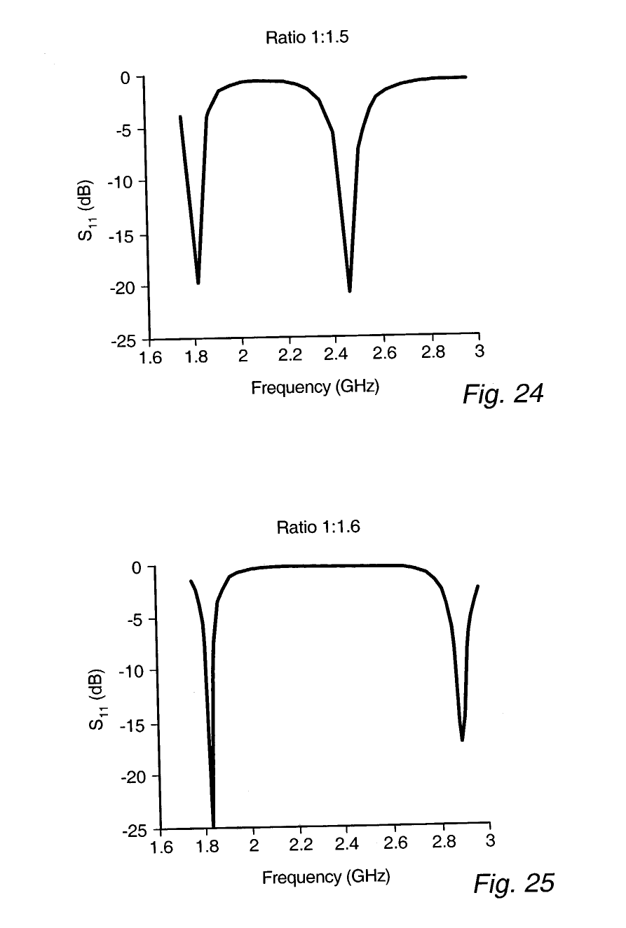

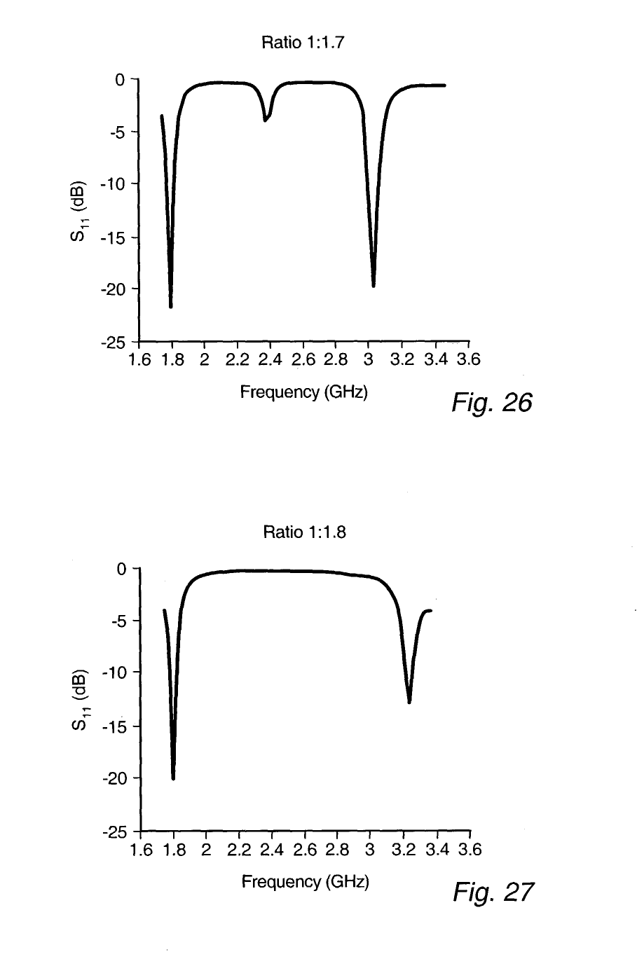

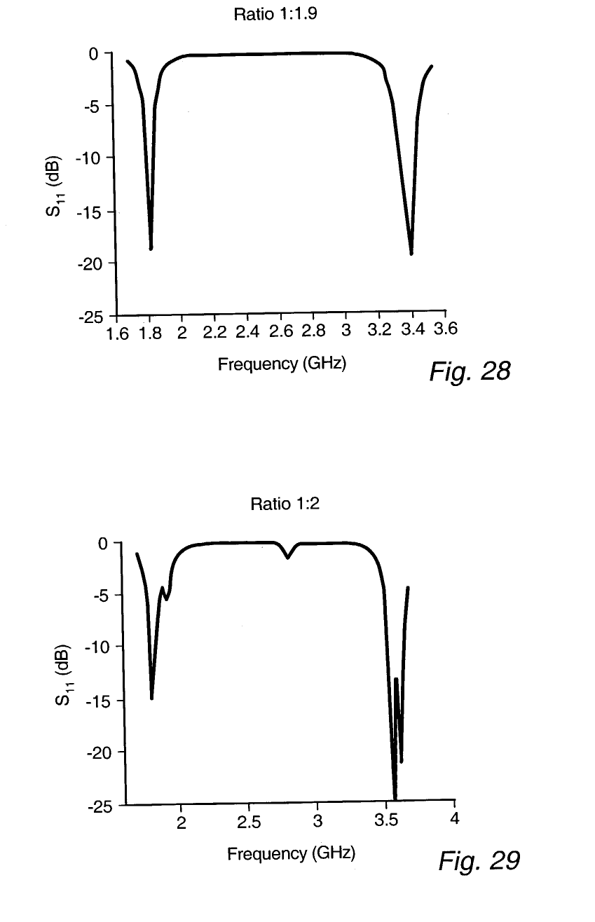

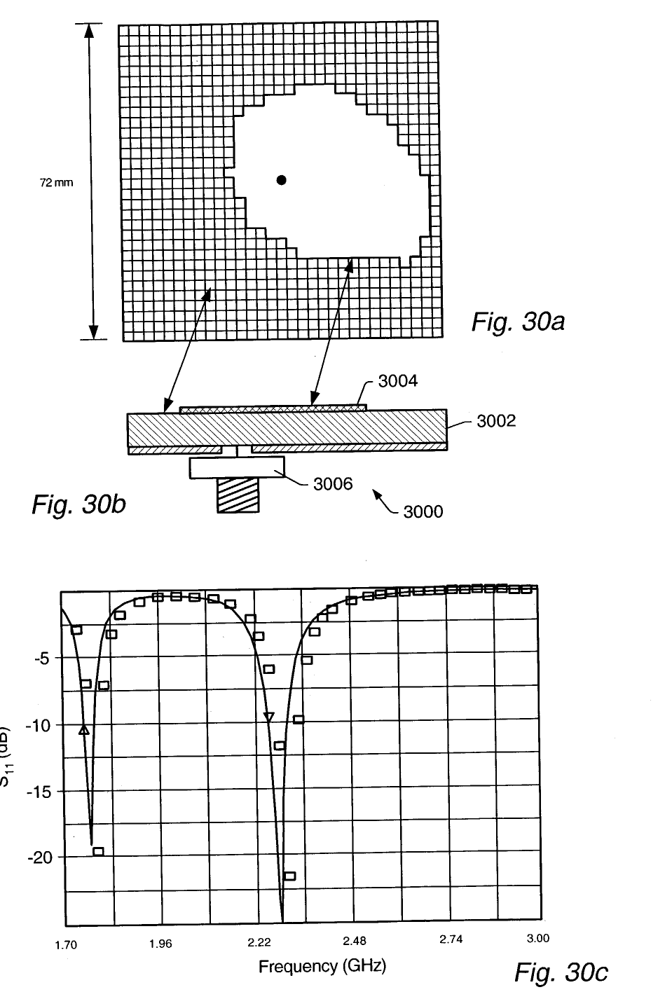

Additional experiments were conducted at various points of the dual-band frequency ratio of about 1:1.1 to 1:2. In these experiments, the low frequency band was fixed at about 1.8 GHz and the high frequency band was varied to vary the dual-band frequency ratio. FIGS. 10-19 depict dual-band antenna shapes optimized for operation at various dual-band frequency ratios. FIGS. 20-29 depict the frequency response curves corresponding to the antennas of FIGS. 10-19, respectively. FIG. 30a depicts the antenna shape of FIG. 12. FIG. 30b depicts a schematic side view of a physical construction of the antenna of FIG. 30a, generally referenced by numeral 3000. Antenna 3000 includes a solid substrate 3002, a conductive layer 3004 on the substrate, and a probe feed 3006. In an embodiment, solid substrate 3002 may include an FR-4 substrate. In other embodiments, substrate 3002 may include another non-conductive solid such as, but not limited to, ceramic, plastic, glass, a laminate, and/or a composite material. Conductive layer 3004 may include a conductive material such as, but not limited to, copper, aluminum, silver, gold, etc. FIG. 30c depicts a number of expected frequency response points for antenna 3000 and the measured frequency response curve for antenna 3000.

### EXAMPLE 3

### Tri-Band Antennas

The microstrip antenna design methodology disclosed herein has an advantage in that multi-band operation may be achieved by the unique patch shapes created. To achieve multi-band operation, the prior art typically requires either adding parasitic patches or using shorting pins. Antenna designs disclosed herein may achieve multi-band operation with good bandwidth by their patch shapes alone. Thus, they may be easier to manufacture and may have a low-cost advantage. These shapes may be scaled in size to a specific operating frequency of interest, or for different substrate materials.

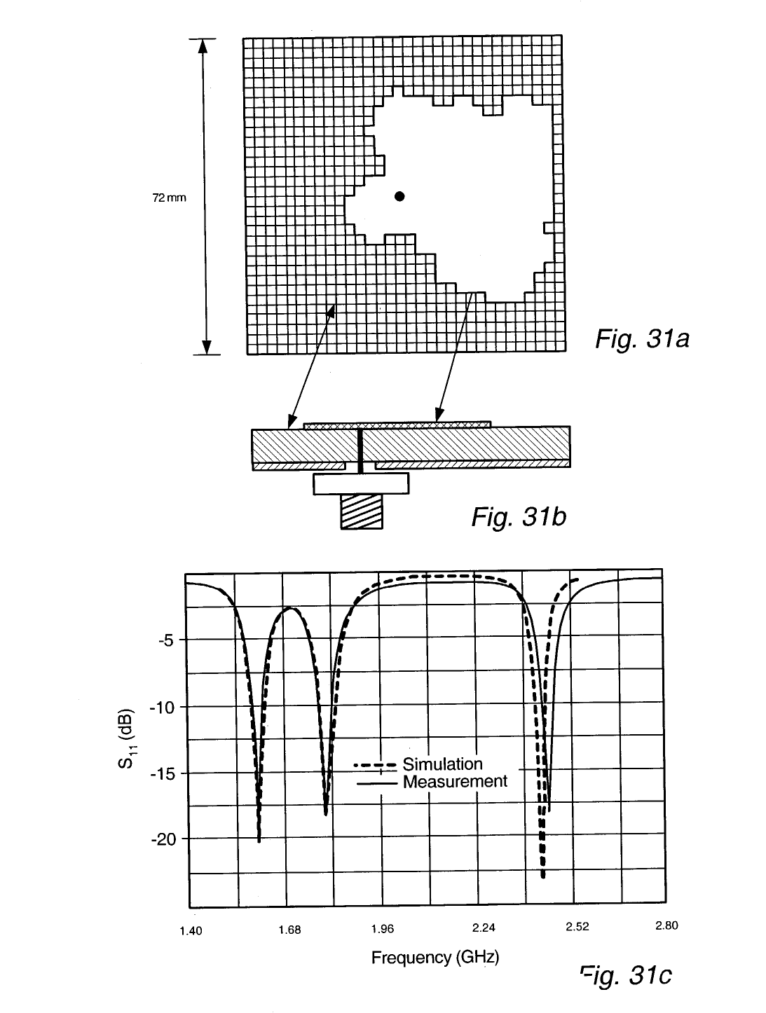

FIG. 31a depicts a tri-band microstrip antenna designed using techniques disclosed herein. The antenna depicted in FIG. 31a operates at about 1.6 GHz (GPS/L1), 1.8 GHz (DCS) and 2.45 GHz (ISM/Bluetooth). FIG. 31b depicts a side view of the microstrip antenna of FIG. 31a built on FR-4 circuit board substrate. FIG. 31c depicts a graph of return loss (dB) of the antenna of FIG. 31a. In FIG. 31c, simulation data are depicted with a dashed line. An antenna was constructed based on the design depicted in FIG. 31a. Experimental results of return loss measurements taken on the antenna are shown as a solid line.

### EXAMPLE 4

### Quad-Band Antennas

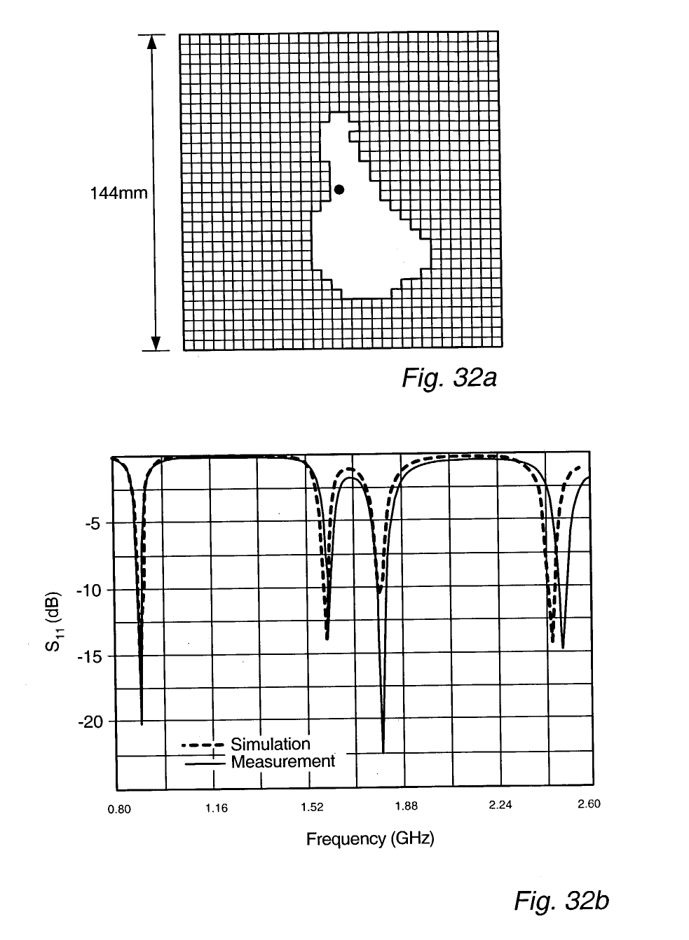

FIG. 32a depicts a quad-band microstrip antenna designed using techniques disclosed herein. The antenna depicted in FIG. 32a operates at about 0.9 GHz, 1.6 GHz, 1.8 GHz and 2.45 GHz. FIG. 32b depicts a graph of return loss (dB) of the antenna of FIG. 32a. In FIG. 32b, simulation data are depicted with a dashed line. An antenna was constructed based on the design depicted in FIG. 32a. Experimental results of return loss measurements taken on the antenna are shown in FIG. 32b as a solid line.

### EXAMPLE 5

### Circular Polarization (CP) Antennas

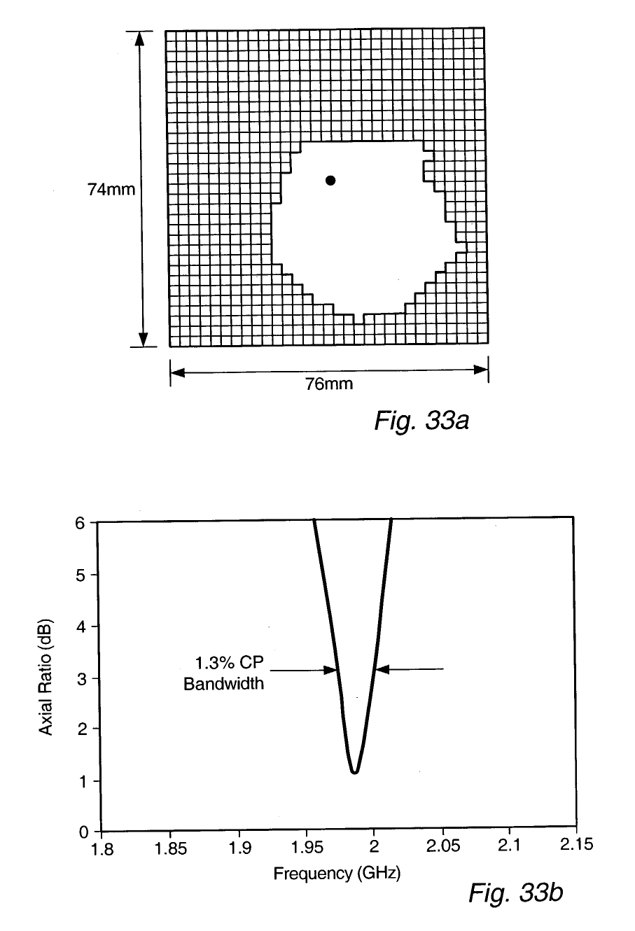

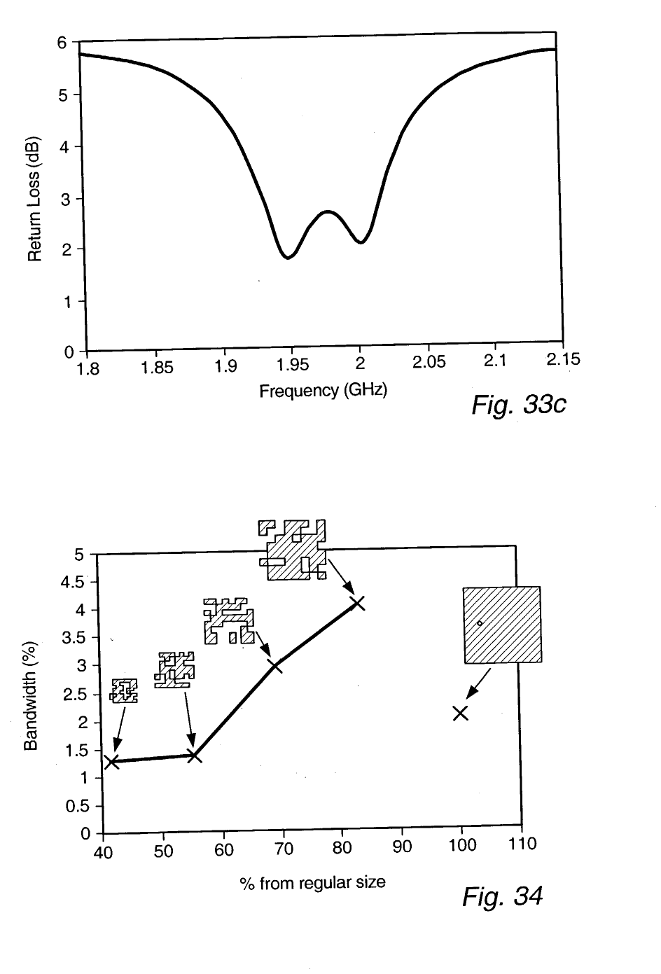

FIG. 33a depicts an embodiment of a broadband CP microstrip antenna. The antenna of FIG. 33a achieves broadband CP operation by its unique patch shape. To achieve broadband CP operation, the prior art typically required either using two feed lines with a 90° phase difference between them or cutting slots on the patch for reactive loading. Embodiments presented herein use a single feed excitation with an arbitrary patch shape. These embodiments may have a low-cost advantage over the two-feed design. These embodiments may also achieve low metal losses and thus may have higher radiation efficiency than the slot designs. In addition, embodiments presented herein are well matched to the feed line over the bandwidth of interest. These designs may be scaled in size to a specific operating frequency of interest or for different substrate materials.

FIG. 33b depicts a graph of the axial ratio (in dB) of the antenna of FIG. 33a from measurements. FIG. 33c depicts a graph of the return loss (dB) of the antenna of FIG. 33a from measurements.

### EXAMPLE 6

### Miniaturized Microstrip Antennas

It is believed that the planar, inverted-F antenna (PIFA) is the most commonly used miniaturized microstrip antenna. PIFAs are limited to a fixed miniaturization ratio of 2:1 along one dimension of the patch. Antennas designed by methods presented herein may be made much smaller than PIFAs. These antennas may be applied to any kind of wireless communication devices that require an antenna size much smaller than the operating wavelength. For example, in the Bluetooth protocol for wireless devices, it is desirable to integrate the antenna directly on the chip package to cut down cost and provide flexible integration. The size of the package (about 1.5 cm, or ⅛ of a wavelength at 2.45 GHz) may pose a significant challenge on the antenna design. Methods presented herein may be applied to design a miniaturized microstrip antenna that can be easily integrated into a small form factor.

FIG. 34 depicts a standard size microstrip antenna along with a number of miniaturized microstrip antenna designed using techniques disclosed herein. In addition, FIG. 34 depicts a graph of the resulting bandwidth of each antennas as a function of the antenna size. The achievable bandwidth of these miniaturized antennas drops as the size of the antenna is reduced. However, FIG. 34 shows that even when the size of the patch is reduced to 40% of the standard size, it still maintains a bandwidth of around 1.3%.

It may also be possible to combine the shaping method presented herein with shorting pins to further miniaturize the antennas while preserving bandwidth and efficiency. A GA may search for an optimal patch shape and pin placement to achieve the smallest possible shape. Multi-band designs may also be designed in this manner.

### EXAMPLE 7

### Dual-Band Microstrip Antennas Using Slots

Microstrip antennas using slots on the conducting patch have been used for miniaturization and dual frequency operations. The design techniques presented herein may be applied to design optimal slot shapes on microstrip patches for multi-band operation with miniaturized antenna size.

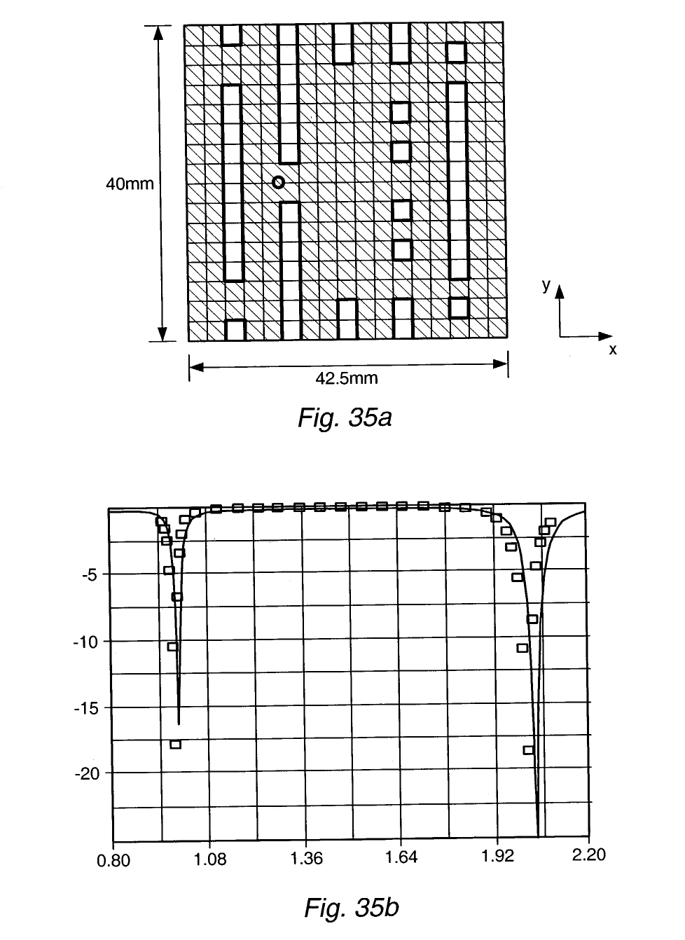

FIG. 35a depicts the slot design on a microstrip patch for dual-band operation at the frequencies of 1.0 GHz and 2.0 GHz. The size of the patch is constrained to be 42.5 mm×40 mm. This patch size is 40% smaller than that of a standard square microstrip working at the frequency of 1 GHz. FIG. 35b depicts the measurement and the simulation results of the return loss. Other than a slight shift in the operating frequencies, the graph shows good agreement between the measurement and the simulation. The bandwidths at the two operating frequencies are 1.2% and 1.37%, respectively.

While the present invention has been described with reference to particular embodiments, it will be understood that the embodiments are illustrated and that the invention scope is not so limited. Any variations, modifications, additions and improvements to the embodiments described are possible. These variations, modifications, additions and improvements may fall within the scope of the invention as detailed within the following claims.

What is claimed is:

1. A multi-band microstrip antenna made by a process comprising:
providing a continuous antenna shape determined by an optimization routine;
providing a solid substrate material; and
forming the antenna shape on the solid substrate material.

2. The antenna of claim 1, wherein the solid substrate material comprises FR-4.

3. The antenna of claim 1, wherein forming the antenna shape on the solid substrate material comprises forming at least one conductive layer on the solid substrate material.

4. The antenna of claim 1, wherein the antenna operates in at least two frequencies ranges.

5. The antenna of claim 1, wherein the antenna operates in at least three frequencies ranges.

6. The antenna of claim 1, wherein the antenna operates in at least four frequencies ranges.

7. The antenna of claim 1, wherein, during use, the antenna has a bandwidth of at least 1.3% at at least one operating frequency.

8. The antenna of claim 1, wherein providing the continuous antenna shape determined by the optimization routine comprises:
determining a desired set of characteristics of the antenna, wherein the desired set of characteristics comprises performance characteristics and manufacturability characteristics;
providing a design matrix to the optimization routine;
providing the desired set of characteristics to the optimization routine; and
determining with the optimization routine the antenna shape, wherein the antenna shape has at least the desired set of characteristics.

9. The antenna of claim 8, wherein determining the antenna shape with the optimization routine comprises:
determining a first antenna shape based on a first design matrix, wherein the first antenna shape does not have the desired set of characteristics;
selecting a second design matrix having a higher resolution than the first design matrix; and
determining the antenna shape based on the second deign matrix and the determined first antenna shape.

10. The antenna of claim 8, wherein the optimization routine comprises a non-deterministic optimization routine.

11. The antenna of claim 8, wherein the optimization routine comprises a genetic algorithm.

12. The antenna of claim 8, wherein determining the antenna shape with the optimization routine comprises selecting one or more initial shapes, and modifying one or more of the initial shapes until at least one of the modified shapes is determined to have at least the desired set of characteristics.

13. The antenna of claim 8, wherein determining the antenna shape with the optimization routine comprises selecting one or more initial shapes, and combining two or more of the initial shapes until at least one of the combined shapes is determined to have at least the desired set of characteristics.

14. The antenna of claim 8, wherein determining the antenna shape with the optimization routine comprises selecting one or more initial shapes, and combining three or more of the initial shapes using two point crossover until at least one of the combined shapes is determined to have at least the desired set of characteristics.

15. The antenna of claim 8, wherein the desired set of characteristics further comprise a maximum size of the antenna.

16. The antenna of claim 1, wherein the design process further comprises determining an antenna probe feed placement with the optimization routine.

17. The antenna of claim 1, wherein the antenna has a physical size of less than about 1.5×1.5 cm² on FR-4 substrate and operating at 2 GHz.

18. The antenna of claim 1, wherein the antenna has a physical size of less than about 1.5×1.5 cm² and wherein the antenna has a bandwidth of at least 1.3% on FR-4 substrate and operating at 2 GHz.

19. The antenna of claim 1, wherein the4 antenna has a physical size of less than about 4×4 cm² on FR-4 substrate and operating between 2 GHz and 4 GHz.

20. The antenna of claim 1, wherein the antenna has a physical size of less than about 4×4 Cm² and wherein the antenna has a bandwidth at at least two frequencies of at least 1.3% on FR-4 substrate and operating between 2 GHz and 4 GHz.

21. The antenna of claim 1, wherein the antenna has a physical size of less than about 5×5 cm² on FR-4 substrate and operating between 1.5 GHz and 3 GHz.

22. The antenna of claim 1, wherein the antenna has a physical size of less than about 5×5 Cm² and wherein the antenna has a bandwidth at at least three frequencies of at least 1.3% on FR-4 substrate and operating between 1.5 GHz and 3 GHz.

23. The antenna of claim 1, wherein the antenna has a physical size of less than about 8×6 cm² on FR-4 substrate and operating between 0.9 GHz and 3 GHz.

24. The antenna of claim 1, wherein the antenna has a physical size of less than about 8×6 cm and wherein the antenna has a bandwidth at at least four frequencies of at least 1.3% on FR-4 substrate and operating between 0.9 GHz and 3 GHz.

25. The antenna of claim 1, wherein the antenna has a physical size of less than about 4.5×4.5 cm² on FR-4 substrate and operating at 2 GHz.

26. The antenna of claim 1, wherein the antenna has a physical size of less than about 4.5×4.5 cm² and wherein the antenna has a bandwidth for circular polarization operation of at least 1.3% on FR-4 substrate and operating at 2 GHz.

27. A multi-band microstrip antenna designed by a process comprising:
determining a desired set of characteristics of the antenna, wherein the desired set of characteristics comprise performance characteristics and manufacturability characteristics;
providing a design matrix to an optimization routine;
providing the desired set of characteristics to the optimization routine; and
determining with the optimization routine an antenna shape, wherein the determined antenna shape has at least the desired set of characteristics.

28. The antenna of claim 27, wherein providing a design matrix to the optimization routine comprises defining an initial resolution of the design matrix.

29. The antenna of claim 27, wherein the performance characteristics comprise at least two frequencies of operation of the antenna.

30. The antenna of claim 27, wherein the performance characteristics comprise at least three frequencies of operation of the antenna.

31. The antenna of claim 27, wherein the performance characteristics comprise at least four frequencies of operation of the antenna.

32. The antenna of claim 27, wherein the performance characteristics comprise a desired bandwidth at at least one frequency of operation of the antenna.

33. The antenna of claim 27, wherein the manufacturability characteristics comprise at least one maximum physical dimension.

34. The antenna of claim 27, wherein the manufacturability characteristics comprise a minimum size of a manufactured feature.

35. The antenna of claim 27, wherein the optimization routine comprises a non-deterministic optimization routine.

36. The antenna of claim 27, wherein the optimization routine comprises a genetic algorithm.

37. The antenna of claim 27, wherein determining the antenna shape with the optimization routine comprises selecting one or more initial shapes, and modifying one or more of the initial shapes until at least one of the modified shapes is determined to have at least the desired set of characteristics.

38. The antenna of claim 27, wherein determining the antenna shape with the optimization routine comprises selecting one or more initial shapes, and combining two or more of the initial shapes until at least one of the combined shapes is determined to have at least the desired set of characteristics.

39. The antenna of claim 27, wherein determining the antenna shape with the optimization routine comprises selecting one or more initial shapes, and combining three or more of the initial shapes using two point crossover until at least one of the combined shapes is determined to have at least the desired set of characteristics.

40. The antenna of claim 27, wherein the design process further comprises determining an antenna probe feed placement based with the optimization routine.

41. The antenna of claim 27, wherein the antenna has a physical size of less than 2 about 1.5×1.5 cm² on FR-4 substrate and operating at 2 GHz.

42. The antenna of claim 27, wherein the antenna has a physical size of less than 2 about 1.5×1.5 cm² and wherein the antenna has a bandwidth of at least 1.3% on FR-4 substrate and operating at 2 GHz.

43. The antenna of claim 27, wherein the antenna has a physical size of less than about 4×4 cm² on FR-4 substrate and operating between 2 GHz and 4 GHz.

44. The antenna of claim 27, wherein the antenna has a physical size of less than about 4×4 cm² and wherein the antenna has a bandwidth at at least two frequencies of at least 1.3% on FR-4 substrate and operating frequency between 2 GHz and 4 GHz.

45. The antenna of claim 27, wherein the antenna has a physical size of less than about 5×5 cm² on FR-4 substrate and operating between 1.5 GHz and 3 GHz.

46. The antenna of claim 27, wherein the antenna has a physical size of less than about 5×5 cm² and wherein the antenna has a bandwidth at at least three frequencies of at least frequency of at least 1.3% on FR-4 substrate and operating between 1.5 GHz and 3 GHz.

47. The antenna of claim 27, wherein the antenna has a physical size of less than about 8×6 cm² on FR-4 substrate and operating between 0.9 GHz and 3 GHz.

48. The antenna of claim 27, wherein the antenna has a physical size of less than about 8×6 cm² and wherein the antenna has a bandwidth at at least four frequencies of at least 1.3% on FR-4 substrate and operating between 0.9 GHz and 3 GHz.

49. The antenna of claim 27, wherein the antenna has a physical size of less than about 4.5×4.5 cm² on FR-4 substrate and operating at 2 GHz.

50. The antenna of claim 27, wherein the antenna has a physical size of less than about 4.5×4.5 cm² and wherein the antenna has a bandwidth for circular polarization operation of at least 1.3% on FR-4 substrate and operating at 2 GHz.

51. A microstrip antenna comprising:
a solid substrate; and
a conductive layer formed on the solid substrate, wherein the conductive layer has a substantially continuous shape, and wherein the shape of the antenna enables the antenna to operate at two or more frequencies.

52. The microstrip antenna of claim 51, wherein the shape of the antenna enables the antenna to operate at three or more frequencies.

53. The microstrip antenna of claim 51, wherein the shape of the antenna enables the antenna to operate at four or more frequencies.

54. The microstrip antenna of claim 51, wherein the shape of the antenna enables the antenna to operate with a bandwidth of at least 1.3% at at least one frequency.

55. The microstrip antenna of claim 51, wherein the antenna has a physical size of less than about 1.5×1.5 cm² on FR-4 substrate and operating at 2 GHz.

56. The microstrip antenna of claim 51, wherein the antenna has a physical size of less than about 1.5×1.5 cm² and wherein the antenna has a bandwidth of at least 1.3% on FR-4 substrate and operating at 2 GHz.

57. The microstrip antenna of claim 51, wherein the antenna has a physical size of less than about 4×4 cm on FR-4 substrate and operating between 2 GHz and 4 GHz.

58. The microstrip antenna of claim 51, wherein the antenna has a physical size of less than about 4×4 cm² and wherein the antenna has a bandwidth at at least two frequencies of at least 1.3% on FR-4 substrate and operating between 2 GHz and 4 GHz.

59. The microstrip antenna of claim 51, wherein the antenna has a physical size of 2 less than about 5×5 cm on FR-4 substrate and operating between 1.5GHz and 3 GHz.

60. The microstrip antenna of claim 51, wherein the antenna has a physical size of less than about 5×5 cm² and wherein the antenna has a bandwidth at at least three frequencies of at least 1.3% on FR-4 substrate and operating between 1.5 GHz and 3 GHz.

61. The microstrip antenna of claim 51, wherein the antenna has a physical size of less than about 8×6 cm² on FR-4 substrate and operating between 0.9 GHz and 3 GHz.

62. The microstrip antenna of claim 51, wherein the antenna has a physical size of less than about 8×6 cm² and wherein the antenna has a bandwidth at at least four frequencies of at least 1.3% on FR-4 substrate and operating between 0.9 GHz and 3 GHz.

63. The microstrip antenna of claim 51, wherein the antenna has a physical size of less than about 4.5×4.5 cm² on FR-4 substrate and operating at 2 GHz.

64. The microstrip antenna of claim 51, wherein the antenna has a physical size of less than about 4.5×4.5 cm² and wherein the antenna has a bandwidth for circular polarization operation of at least 1.3% on FR-4 substrate and operating at 2 GHz.

65. A method of designing a microstrip antenna comprising:
providing a set of desired characteristics to an optimization program;
providing a design grid, wherein the design grid is formed of a plurality of design elements, and wherein the design grid defines limitations on physical dimensions of the antenna;
determining at least one first antenna shape;
modifying at least first antenna shape;
determine if at least one modified antenna shape approaches the desired set of characteristics more closely than at least one first antenna shape.

66. The method of claim 65, further comprising iteratively repeating the modification and comparison of at least two antenna shapes until an antenna shape is determined to have the desired set of performance characteristics.

67. The method of claim 65, further comprising providing information regarding a substrate upon which the antenna is to be formed.

68. The method of claim 65, further comprising providing information regarding a conducting material to be used in forming the antenna.

69. The method of claim 65, wherein the set of desired characteristics comprises at least two frequencies at which the antenna design antenna should function.

70. The method of claim 65, wherein the set of desired characteristics comprises at least three frequencies at which the antenna design antenna should function.

71. The method of claim 65, wherein the set of desired characteristics comprises at least four frequencies at which the antenna design antenna should function.

72. The method of claim 65, wherein the set of desired characteristics comprises at least one desired bandwidth at at least one frequency.

73. The method of claim 65, wherein the set of desired characteristics comprises a maximum physical dimension for the antenna.

74. The method of claim 65, wherein the set of desired characteristics comprises one or more manufacturing characteristics.

75. The method of claim 65, wherein modifying at least first antenna shape comprises mutating at least one first antenna shape.

76. The method of claim 65, wherein modifying at least first antenna shape comprises combining at least portions of two or more first antenna shapes.

77. The method of claim 65, wherein modifying at least first antenna shape comprises combining at least portions of three or more first antenna shapes.

78. The method of claim 65, wherein modifying at least first antenna shape comprises changing a location of an antenna probe feed.

79. The method of claim 65, further comprising determining placement of an antenna probe feed.

80. The method of claim 65, further comprising determining placement of one or more slots in the antenna shape.

81. The method of claim 65, wherein modifying at least first antenna shape comprises changing a location of a slot in the antenna shape.

82. The method of claim 65, further comprising determining dimensions of one or more slots in the antenna shape.

83. The method of claim 65, wherein modifying at least first antenna shape comprises changing a dimension of a slot in the antenna shape.

84. The method of claim 65, further comprising modifying the design grid to increase the resolution of the design grid if an antenna shape having the set of desired characteristics is not determined.

85. The method of claim 65, further comprising modifying one or more antenna shapes to ensure that specified geometric characteristics are maintained.
